(19) United States
(12) Patent Application Publication
(10) Pub. No.: US 2012/0127113 A1
(43) Pub. Date: May 24, 2012

(54) FLEXIBLE RESISTIVE TOUCH SENSOR STRUCTURE

(75) Inventors: Bao-Shun Yau, Kaohsiung City (TW); Chih-Chiang Lu, Taipei County (TW); Chung-Huang Huang, Hsinchu County (TW)

(73) Assignee: INDUSTRIAL TECHNOLOGY RESEARCH INSTITUTE, Hsinchu (TW)

(21) Appl. No.: 12/951,074

(22) Filed: Nov. 22, 2010

(51) Int. Cl. G06F 3/045

(52) U.S. Cl. 345/174; 977/742; 178/18.05

(57) ABSTRACT

A flexible resistive touch sensor structure includes a roll of first and a roll of second flexible transparent substrates, first connection wires, second connection wires, spacer dots and insulation frames. The rolls of first and the second flexible transparent substrate have first and second electrode unit regions thereon respectively. Each first electrode unit region includes at least one first transparent electrode. Each second electrode unit region includes at least one second transparent electrode correspondingly facing to the first electrode unit regions. The first connection wires are connected to the first transparent electrodes. The second connection wires are connected to the second transparent electrodes. The spacer dots are disposed between the first and the second transparent electrodes. The insulation frame seal surroundings of the first electrode unit regions and the second electrode unit regions corresponding to each other respectively and isolate the first and the second connection wires respectively.

### BACKGROUND

1. Field of the Disclosure

The disclosure relates to a touch sensor structure. Particularly, the disclosure relates to a flexible resistive touch sensor structure.

2. Description of Related Art

Display technique is developed towards a trend of a more user-friendly man-machine interface. In the past, panel operations are generally performed through specified mechanical buttons. With development of flat panel displays, touch panels are widely used to replace input devices such as keyboards and mouses, etc., so as to facilitate users to easily operate various information products. Therefore, a touch panel era with easy operation is coming, for example, vehicle touch panels (for vehicle navigation), game machines, public information systems (for example, vending machines, automatic teller machines (ATMs), guide systems, etc.), industrial uses, and small electronic products (for example, personal digital assistants (PDAs), e-books), etc. Competition in such field is intense, and major production countries include Japan, Taiwan, the United States, South Korea and China. Almost all of the world's leading manufacturers are actively engaged in such technical domain, and it is expected that the market demand of the touch panels in the next few years may have a significant growth.

During a fabrication process of a conventional resistive touch panel, an indium tin oxide/polyethylene terephthalate (ITO/PET) layer serving as an upper conductive layer and an ITO/glass or ITO/PET layer serving as a lower conductive layer are all cut into suitable sizes, and then are manually adhered and aligned. Dozens of processing steps are performed in a sheet type from the electrode pattern till final lamination of the upper and the lower layers, and many processing steps have to be completed by manpower, so that a mass production thereof is limited.

According to the fabrication process of the conventional resistive touch panel, a flexible substrate is generally adhered to a carrier for fabrication, or a single piece of the flexible substrate with a small area is adhered with a flexible bottom plate for fabrication. The sheet-type units have to be repeatedly loaded to and unloaded from an additional carrier. Each of the sheet-type units requires a batch type equipment, and the required process equipments and processing steps are relatively more. The production line is not fully automated, and the fabrication process is labor-intensive, which results in a slow mass production rate and a production yield is difficult to be controlled.

### SUMMARY OF THE DISCLOSURE

Accordingly, the disclosure is directed to a flexible resistive touch sensor structure, which is a roll of product and has features of easy management and facilitating follow-up processing.

The disclosure is directed to a flexible resistive touch sensor structure, by which fabrication processes can be simplified.

The disclosure is directed to a flexible resistive touch sensor structure, which can be produced through fully automated production.

The disclosure provides a flexible resistive touch sensor structure including a roll of first flexible transparent substrate, a roll of second flexible transparent substrate, a plurality of first connection wires, a plurality of second connection wires, a plurality of spacer dots and a plurality of insulation frames. The roll of first flexible transparent substrate has a plurality of first electrode unit regions thereon, and each of the first electrode unit regions includes at least one first transparent electrode. The roll of second flexible transparent substrate has a plurality of second electrode unit regions thereon, and each of the second electrode unit regions includes at least one second transparent electrode, and the second electrode unit regions correspondingly face to the first electrode unit regions. The first connection wires are connected to the first transparent electrodes. The second connection wires are connected to the second transparent electrodes. The spacer dots are disposed between the first transparent electrodes and the second transparent electrodes for isolating the first transparent electrodes and the second transparent electrodes in a non-touch situation. The insulation frames seal surroundings of the first electrode unit regions and the second electrode unit regions corresponding to each other respectively and isolate the first connection wires and the second connection wires respectively.

The disclosure provides a flexible resistive touch sensor structure including a roll of first flexible transparent substrate, a roll of second flexible transparent substrate, a plurality of first electrical connection terminals, a plurality of second electrical connection terminals, a plurality of first connection wires, a plurality of conducting contacts, a plurality of second connection wires, a plurality of spacer dots and a plurality of insulation frames. The roll of first flexible transparent substrate has a plurality of first electrode unit regions and a plurality of openings thereon, and each of the first electrode unit regions includes at least one first transparent electrode. The roll of second flexible transparent substrate has a plurality of second electrode unit regions thereon, and each of the second electrode unit regions includes at least one second transparent electrode, and the second electrode unit regions correspondingly face to the first electrode unit regions. The first electrical connection terminals and the second electrical connection terminals are disposed on the roll of second flexible transparent substrate. The first connection wires are connected to the first transparent electrodes. The conducting contacts are connected to the first connection wires and the first electrical connection terminals. The second connection wires are connected to the second transparent electrodes and have the second electrical connection terminals. The spacer dots are disposed between the first transparent electrodes and the second transparent electrodes for isolating the first transparent electrodes and the second transparent electrodes in a non-touch situation. The insulation frames seal surroundings of the first electrode unit regions and the second electrode unit regions corresponding to each other respectively and isolate the first connection wires and the second connection wires respectively. The openings expose the first electrical connection terminals and the second electrical connection terminals.

The disclosure provides a flexible resistive touch sensor structure including a roll of first flexible transparent substrate, a roll of second flexible transparent substrate, a plurality of first electrical connection terminals, a plurality of second electrical connection terminals, a plurality of first connection wires, a plurality of conducting contacts, a plurality of second connection wires, a plurality of flexible printed circuits (FPCs), a plurality of spacer dots and a plurality of insulation frames. The roll of first flexible transparent substrate has a plurality of first electrode unit regions and a plurality of openings thereon, and each of the first electrode unit regions includes at least one first transparent electrode. The roll of second flexible transparent substrate has a plurality of second electrode unit regions thereon, and each of the second electrode unit regions includes at least one second transparent electrode, and the second electrode unit regions correspondingly face to the first electrode unit regions. The first electrical connection terminals and the second electrical connection terminals are disposed on the roll of second flexible transparent substrate. The first connection wires are connected to the first transparent electrodes. The conducting contacts are connected to the first connection wires and the first electrical connection terminals. The second connection wires are connected to the second transparent electrodes and have the second electrical connection terminals. The flexible printed circuits pass through the openings and are connected to the first electrical connection terminals and the second electrical connection terminals exposed by the openings. The spacer dots are disposed between the first transparent electrodes and the second transparent electrodes for isolating the first transparent electrodes and the second transparent electrodes in a non-touch situation. The insulation frames seal surroundings of the first electrode unit regions and the second electrode unit regions corresponding to each other respectively and isolate the first connection wires and the second connection wires respectively.

According to the above descriptions, the flexible resistive touch sensor structure of the disclosure is a roll of product, which has features of ease management and facilitating follow-up processing. Therefore, during a fabrication process of the flexible resistive touch sensor structure of the disclosure, a roll to roll (R2R) process can be used to implement a fully automated production, which has following features: usage of a carrier is unnecessary, the fabrication processes are simplified, productivity and unit investment returns are improved, manpower operating variables are reduced, and production yield is improved.

In order to make the aforementioned and other features of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a top view of a flexible resistive touch sensor structure before lamination according to a first exemplary embodiment of the disclosure.

FIG. 2 is a cross-sectional view of the flexible restive touch sensor structure of FIG. 1 after lamination viewing along a section line I-I′ of FIG. 1.

FIG. 3 is a top view of a flexible resistive touch sensor structure before lamination according to a second exemplary embodiment of the disclosure.

FIG. 4 is a cross-sectional view of the flexible restive touch sensor structure of FIG. 3 after lamination viewing along a section line II-II′ of FIG. 3.

FIG. 5 is a cross-sectional view of the flexible restive touch sensor structure of FIG. 3 after lamination viewing along a section line III-III′ of FIG. 3.

FIG. 6 is a cross-sectional view of a flexible resistive touch sensor structure after lamination viewing along a section line II-II′ of FIG. 3 according to a third exemplary embodiment of the disclosure.

FIG. 7 is a cross-sectional view of a flexible resistive touch sensor structure after lamination viewing along a section line III-III′ of FIG. 3 according to a third exemplary embodiment of the disclosure.

### DETAILED DESCRIPTION OF DISCLOSED EMBODIMENTS

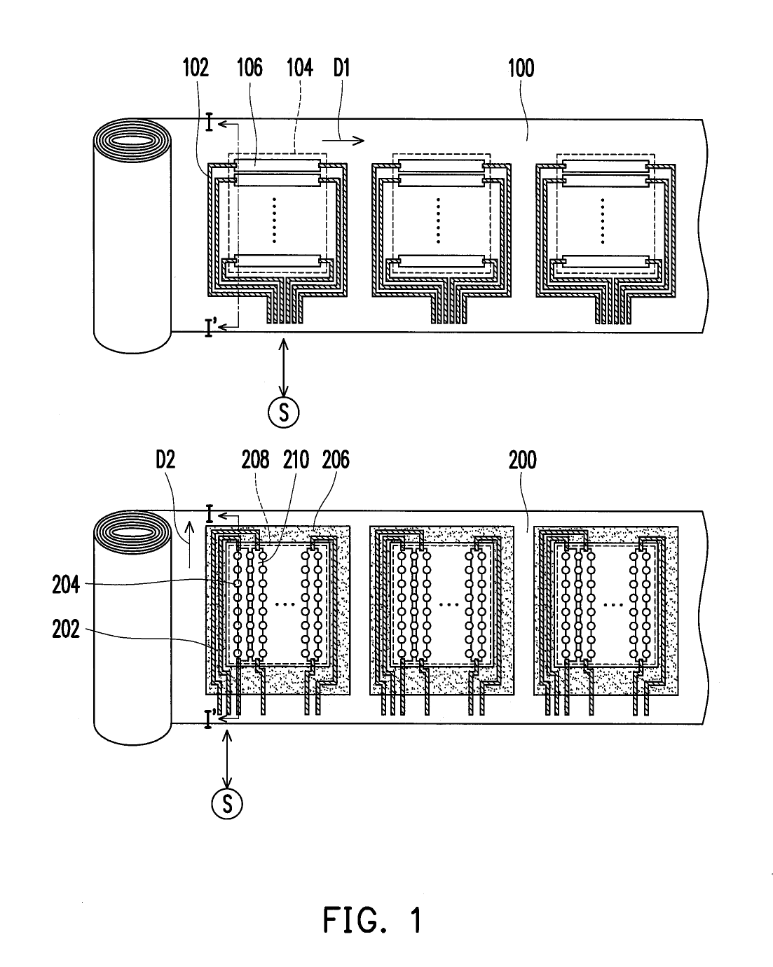

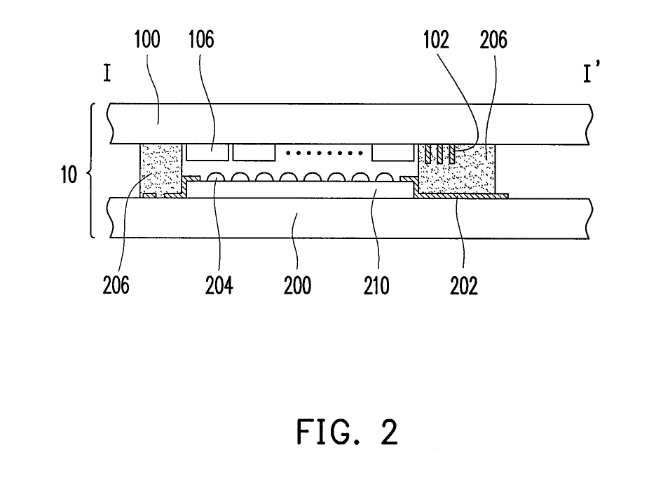

FIG. 1 is a top view of a flexible resistive touch sensor structure before lamination according to a first exemplary embodiment of the disclosure. FIG. 2 is a cross-sectional view of the flexible restive touch sensor structure of FIG. 1 after lamination viewing along a section line I-I′ of FIG. 1.

Referring to FIG. 1 and FIG. 2, the flexible resistive touch sensor structure 10 includes a roll of first flexible transparent substrate 100, a roll of second flexible transparent substrate 200, a plurality of first connection wires 102, a plurality of second connection wires 202, a plurality of spacer dots 204 and a plurality of insulation frames 206. Materials of the roll of first flexible transparent substrate 100 and the roll of second flexible transparent substrate 200 are, for example, respectively polyethylene terephthalate, polycarbonate or flexible glass.

The roll of first flexible transparent substrate 100 has a plurality of first electrode unit regions 104 thereon. Each of the first electrode unit regions 104 includes at least one first transparent electrode 106. A material of the first transparent electrodes 106 is, for example, transparent conductive oxide, an organic transparent conductive material, nano metal or carbon nanotube, where the transparent conductive oxide is, for example, indium tin oxide (ITO) or indium zinc oxide (IZO), the organic transparent conductive material is, for example, poly(3,4-ethylenedioxythiophene):poly (styrenesulfonate) (PEDOT:PPS). Moreover, the first transparent electrodes 106 can be a single-layer structure or a multi-layer structure. If the first transparent electrodes 106 are the multi-layer structures, the multi-layer structures of the first transparent electrode 106 are, for example, stack combinations of transparent metal oxide layers and a metal layer, which can be stack structures of transparent metal oxide layer/metal layer/transparent metal oxide layer, for example, ITO/Ag/ITO or IZO/Ag/IZO.

The roll of second flexible transparent substrate 200 has a plurality of second electrode unit regions 208 thereon, and each of the second electrode unit regions 208 includes at least one second transparent electrode 210, and the second electrode unit regions 208 correspondingly face to the first electrode unit regions 104. The first electrode unit regions 104 and the second electrode unit regions 208 can serve as a viewing area of the flexible resistive touch sensor structure 10. The second electrode unit regions 208 and the first electrode unit regions 104 may form a plurality of electrode unit groups in a one-to-one manner, and one electrode unit group can be used to form one flexible resistive touch sensor, though the disclosure is not limited thereto. A material of the second transparent electrodes 210 is, for example, transparent conductive oxide, an organic transparent conductive material, nano metal or carbon nanotube, where the transparent conductive oxide is, for example, ITO or IZO, the organic transparent conductive material is, for example, PEDOT:PPS. Moreover, the second transparent electrodes 210 can be a single-layer structure or a multi-layer structure. If the second transparent electrodes 210 are the multi-layer structures, the multi-layer structures of the second transparent electrode 210 are, for example, stack combinations of transparent metal oxide layers and a metal layer, which can be stack structures of transparent metal oxide layer/metal layer/transparent metal oxide layer, for example, ITO/Ag/ITO or IZO/Ag/IZO.

In the present exemplary embodiment, each of the first electrode unit regions 104 may have a plurality of the first transparent electrodes 106 arranged in parallel, and the first transparent electrodes 106 are, for example, extended along a first direction D1, though the disclosure is not limited thereto. Moreover, each of the second electrode unit regions 208 may have a plurality of the second transparent electrodes 210 arranged in parallel, and the second transparent electrodes 210 are, for example, extended along a second direction D2, where the second direction D2 is intersected with the first direction D1, though the disclosure is not limited thereto. In other embodiments, each of the first electrode unit regions 104 may only include a single first transparent electrode 106, and each of the second electrode unit regions 208 may only include a single second transparent electrode 210. Furthermore, the first electrode unit regions 104 and the second electrode unit regions 208 can be disposed repeatedly along the first direction D1 and/or the second direction D2.

The first connection wires 102 are connected to the first transparent electrodes 106, and the first connection wires 102 are used for transmitting an external signal S to the first transparent electrodes 106. A material of the first connection wires 102 is, for example, conductive silver paste or a metal material, where the metal material can be a copper-containing metal material, or a multi-layer material of molybdenum/aluminium/molybdenum (Mo/Al/Mo), etc. Moreover, those skilled in the art can design and adjust the external signal S transmitted to the first transparent electrodes 106 by themselves.

The second connection wires 202 are connected to the second transparent electrodes 210, and the second connection wires 202 are used for transmitting the external signal S to the second transparent electrodes 210. A material of the second connection wires 202 is, for example, conductive silver paste or a metal material, where the metal material can be a copper-containing metal material, or a multi-layer material of Mo/Al/Mo, etc. Moreover, those skilled in the art can design and adjust the external signal S transmitted to the second transparent electrodes 210 by themselves.

The spacer dots 204 are disposed between the first transparent electrodes 106 and the second transparent electrodes 210 for isolating the first transparent electrodes 106 and the second transparent electrodes 210 in a non-touch situation. In the present exemplary embodiment, the spacer dots 204 are, for example, disposed on the roll of second flexible transparent substrate 200, though the disclosure is not limited thereto. A material of the spacer dots 204 is, for example, a dielectric material such as resin, for example, photosensitive resin or thermosetting resin.

The insulation frames 206 seal surroundings of the first electrode unit regions 104 and the second electrode unit regions 208 corresponding to each other respectively, and isolate the first connection wires 102 and the second connection wires 202 respectively. A material of the insulation frames 206 is, for example, ultraviolet-sensitive adhesive.

According to the above descriptions, it is known that the flexible resistive touch sensor structure 10 is a roll of product, i.e. the flexible resistive touch sensor structure 10 can be extended along a machine direction (MD) of the product substrate and can be rolled up to be a roll, so that it has features of easy management and facilitating follow-up processing.

Therefore, during a fabrication process of the flexible resistive touch sensor structure 10 of the present exemplary embodiment, a roll to roll (R2R) process can be used to implement a fully automated production, which has following features: usage of a carrier is unnecessary, the fabrication processes are simplified, productivity and unit investment returns are improved, manpower operating variables are reduced, and production yield is improved.

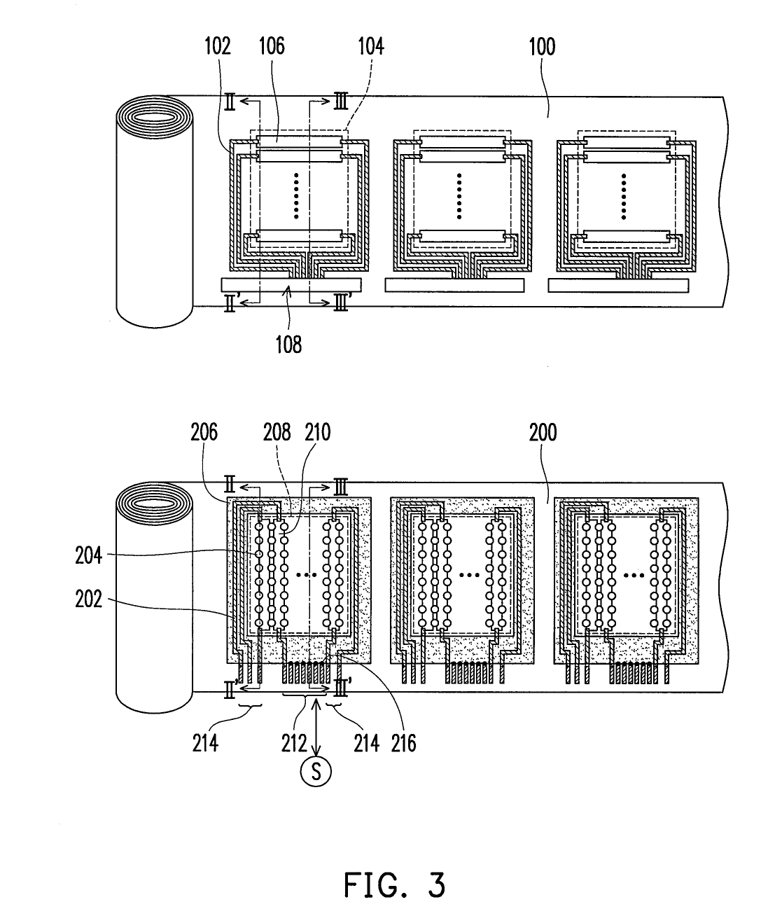

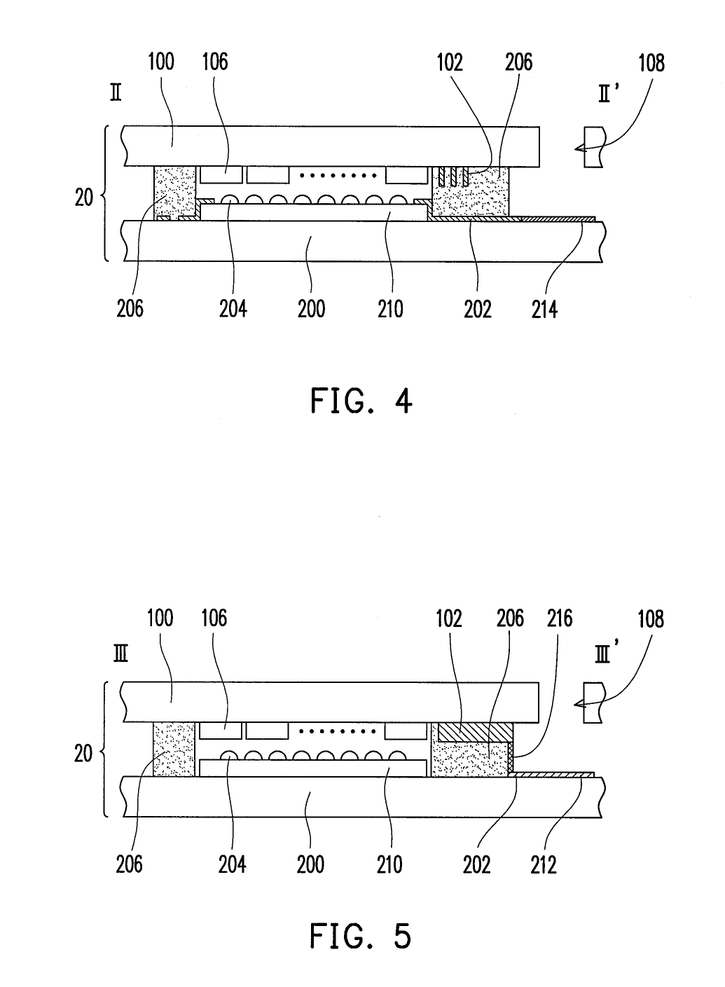

FIG. 3 is a top view of a flexible resistive touch sensor structure before lamination according to a second exemplary embodiment of the disclosure. FIG. 4 is a cross-sectional view of the flexible restive touch sensor structure of FIG. 3 after lamination viewing along a section line II-II′ of FIG. 3. FIG. 5 is a cross-sectional view of the flexible restive touch sensor structure of FIG. 3 after lamination viewing along a section line of FIG. 3.

Referring to FIG. 1 to FIG. 5, a difference between the flexible resistive touch sensor structure 20 of the second exemplary embodiment and the flexible resistive touch sensor structure 10 of the first exemplary embodiment is that the flexible resistive touch sensor structure 20 further includes a plurality of first electrical connection terminals 212, a plurality of second electrical connection terminals 214 and a plurality of conducting contacts 216, and the roll of first flexible transparent substrate 100 of the flexible resistive touch sensor structure 20 has a plurality of openings 108. Materials, configuration manners and functions of the other components in the flexible resistive touch sensor structure 20 are similar to that in the flexible resistive touch sensor structure 10, so that these components are indicated by the same referential numerals, and descriptions thereof are not repeated.

Referring to FIG. 3 to FIG. 5, the first electrical connection terminals 212 and the second electrical connection terminals 214 are disposed on the roll of second flexible transparent substrate 200. The openings 108 expose the first electrical connection terminals 212 and the second electrical connection terminals 214, and the first connection wires 102 are, for example, extended to edges of the openings 108.

Materials of the first electrical connection terminals 212 and the second electrical connection terminals 214 are, for example, respectively conductive silver paste or a metal material, where the metal material can be a copper-containing metal material, or a multi-layer material of Mo/Al/Mo, etc.

The conducting contacts 216 are connected to the first connection wires 102 and the first electrical connection terminals 212. A material of the conducting contacts 216 is, for example, conductive silver paste. Since the first connection wires 102 are connected to the first transparent electrodes 106, the first electrical connection terminals 212 can transmit the external signal S to the first transparent electrodes 106 through the conducting contacts 216 and the first connection wires 102.

Moreover, since the second connection wires 202 are connected to the second transparent electrodes 210 and have the second electrical connection terminals 214, the second electrical connection terminals 214 can transmit the external signal S to the second transparent electrodes 210 through the second connection wires 202. The second connection wires 202 and the corresponding second electrical connection terminals 214 can be integrally formed or independently formed, for example.

According to the above descriptions, the flexible resistive touch sensor structure 20 is a roll of product, which has features of easy management and facilitating follow-up processing, and the roll to roll (R2R) process can be used to implement a fully automated production.

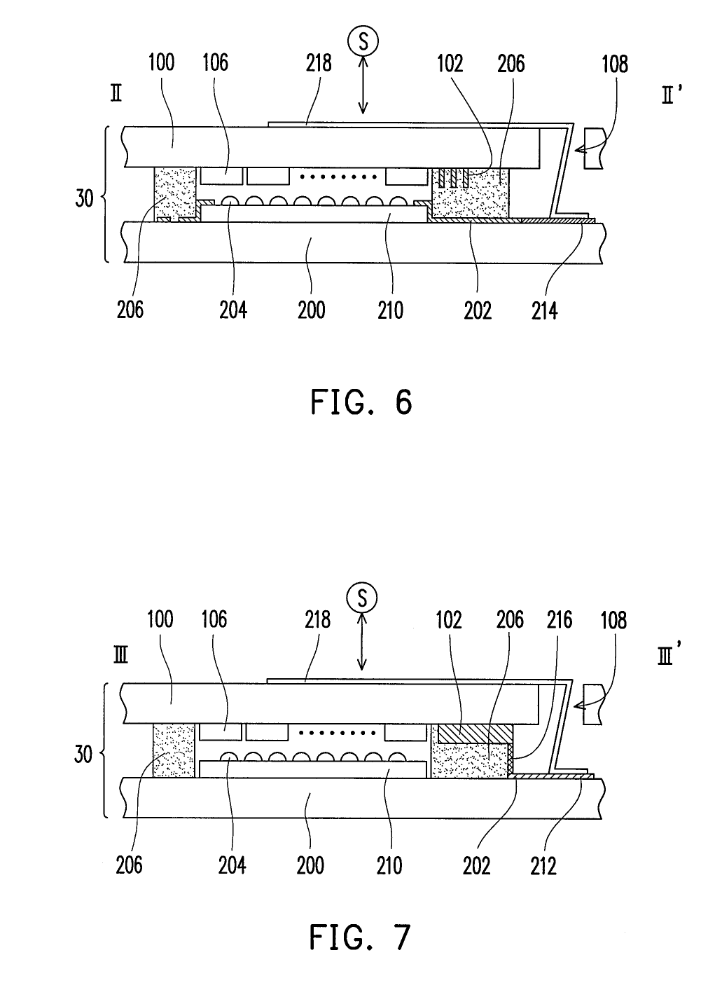

FIG. 6 is a cross-sectional view of a flexible resistive touch sensor structure after lamination viewing along the section line II-II′ of FIG. 3 according to a third exemplary embodiment of the disclosure. FIG. 7 is a cross-sectional view of a flexible resistive touch sensor structure after lamination viewing along a section line III-III′ of FIG. 3 according to a third exemplary embodiment of the disclosure.

Referring to FIG. 3 to FIG. 7, a difference between the flexible resistive touch sensor structure 30 of the third exemplary embodiment and the flexible resistive touch sensor structure 20 of the second exemplary embodiment is that the flexible resistive touch sensor structure 30 further includes a plurality of flexible printed circuits (FPCs) 218. The flexible FPCs 218 pass through the openings 108 and are connected to the first electrical connection terminals 212 and the second electrical connection terminals 214 exposed by the openings 108. Therefore, the flexible FPCs 218 can transmit the external signal S to the first transparent electrodes 106 through the first electrical connection terminals 212, the conducting contacts 216 and the first connection wires 102, and can simultaneously transmit the external signal S to the second transparent electrodes 210 through the second electrical connection terminals 214 and the second connection wires 202. Materials, configuration manners and functions of the other components in the flexible resistive touch sensor structure 30 are similar to that in the flexible resistive touch sensor structure 20, so that these components are indicated by the same referential numerals, and descriptions thereof are not repeated.

According to the above descriptions, the flexible resistive touch sensor structure 30 is a roll of product, which has features of easy management and facilitating follow-up processing, and the roll to roll (R2R) process can be used to implement a fully automated production.

The flexible resistive touch sensor structures 10, 20 and 30 of the above exemplary embodiments can be fabricated through a fully automated continuous R2R process. Taking a fabrication process of the flexible resistive touch sensor structure 20 as an example, the first transparent electrodes 106 and the second transparent electrodes 210 can be respectively fabricated on the roll of first flexible transparent substrate 100 and the roll of second flexible transparent substrate 200 through the R2R process. Then, the R2R process is used to print the first connection wires 102, the second connection wires 202, the spacer dots 204, the insulation frames 206, the first electrical connection terminals 212, the second electrical connection terminals 214 and the conducting contacts 216, and then a R2R lamination process is performed to the roll of first flexible transparent substrate 100 and the roll of second flexible transparent substrate 200, so as to fabricate the flexible resistive touch sensor structure 20, though the disclosure is not limited thereto. In other embodiments, the first connection wires 102, the second connection wires 202, the first electrical connection terminals 212 and the second electrical connection terminals 214 in the flexible resistive touch sensor structure 20 can also be fabricated through a vacuum deposition process and a patterning process.

In summary, the aforementioned exemplary embodiments has at least the following features:
1. The flexible resistive touch sensor structures provided by the aforementioned exemplary embodiments are roll of products, which have features of easy management and facilitating follow-up processing.
2. Fabrication processes can be simplified according to the design of the flexible resistive touch sensor structures provided by the aforementioned exemplary embodiments.
3. A fully automated production of the flexible resistive touch sensor structures provided by the aforementioned exemplary embodiments can be implemented.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A flexible resistive touch sensor structure, comprising:
a roll of first flexible transparent substrate, having a plurality of first electrode unit regions thereon, and each of the first electrode unit regions comprising at least one first transparent electrode;
a roll of second flexible transparent substrate, having a plurality of second electrode unit regions thereon, and each of the second electrode unit regions comprising at least one second transparent electrode, wherein the second electrode unit regions correspondingly face to the first electrode unit regions;
a plurality of first connection wires, connected to the first transparent electrodes;
a plurality of second connection wires, connected to the second transparent electrodes;
a plurality of spacer dots, disposed between the first transparent electrodes and the second transparent electrodes, for isolating the first transparent electrodes and the second transparent electrodes in a non-touch situation; and
a plurality of insulation frames, sealing surroundings of the first electrode unit regions and the second electrode unit regions corresponding to each other respectively, and isolating the first connection wires and the second connection wires respectively.

2. The flexible resistive touch sensor structure as claimed in claim 1, wherein materials of the roll of first flexible transparent substrate and the roll of second flexible transparent substrate respectively comprise polyethylene terephthalate, polycarbonate or flexible glass.

3. The flexible resistive touch sensor structure as claimed in claim 1, wherein materials of the first transparent electrodes and the second transparent electrodes respectively comprise transparent conductive oxide, an organic transparent conductive material, nano metal or carbon nanotube.

4. The flexible resistive touch sensor structure as claimed in claim 1, wherein the first transparent electrodes and the second transparent electrodes respectively comprise single-layer structures or multi-layer structures.

5. The flexible resistive touch sensor structure as claimed in claim 1, wherein materials of the first connection wires and the second connection wires respectively comprise conductive silver paste or a metal material.

6. The flexible resistive touch sensor structure as claimed in claim 1, wherein a material of the spacer dots comprises a dielectric material.

7. The flexible resistive touch sensor structure as claimed in claim 1, wherein a material of the insulation frames comprises ultraviolet-sensitive adhesive.

8. A flexible resistive touch sensor structure, comprising:
a roll of first flexible transparent substrate, having a plurality of first electrode unit regions and a plurality of openings thereon, and each of the first electrode unit regions comprising at least one first transparent electrode;
a roll of second flexible transparent substrate, having a plurality of second electrode unit regions thereon, and each of the second electrode unit regions comprising at least one second transparent electrode, wherein the second electrode unit regions correspondingly face to the first electrode unit regions;
a plurality of first electrical connection terminals and a plurality of second electrical connection terminals, disposed on the roll of second flexible transparent substrate;
a plurality of first connection wires, connected to the first transparent electrodes;
a plurality of conducting contacts, connected to the first connection wires and the first electrical connection terminals;
a plurality of second connection wires, connected to the second transparent electrodes and having the second electrical connection terminals;
a plurality of spacer dots, disposed between the first transparent electrodes and the second transparent electrodes, for isolating the first transparent electrodes and the second transparent electrodes in a non-touch situation; and
a plurality of insulation frames, sealing surroundings of the first electrode unit regions and the second electrode unit regions corresponding to each other respectively, and isolating the first connection wires and the second connection wires respectively, wherein
the openings expose the first electrical connection terminals and the second electrical connection terminals.

9. The flexible resistive touch sensor structure as claimed in claim 8, wherein materials of the roll of first flexible transparent substrate and the roll of second flexible transparent substrate respectively comprise polyethylene terephthalate, polycarbonate or flexible glass.

10. The flexible resistive touch sensor structure as claimed in claim 8, wherein materials of the first transparent electrodes and the second transparent electrodes respectively comprise transparent conductive oxide, an organic transparent conductive material, nano metal or carbon nanotube.

11. The flexible resistive touch sensor structure as claimed in claim 8, wherein the first transparent electrodes and the second transparent electrodes respectively comprise single-layer structures or multi-layer structures.

12. The flexible resistive touch sensor structure as claimed in claim 8, wherein materials of the first connection wires and the second connection wires respectively comprise conductive silver paste or a metal material.

13. The flexible resistive touch sensor structure as claimed in claim 8, wherein a material of the spacer dots comprises a dielectric material.

14. The flexible resistive touch sensor structure as claimed in claim 8, wherein a material of the insulation frames comprises ultraviolet-sensitive adhesive.

15. The flexible resistive touch sensor structure as claimed in claim 8, wherein materials of the first electrical connection terminals and the second electrical connection terminals respectively comprise conductive silver paste or a metal material.

16. The flexible resistive touch sensor structure as claimed in claim 8, wherein a material of the conducting contacts comprises conductive silver paste.

17. A flexible resistive touch sensor structure, comprising:
a roll of first flexible transparent substrate, having a plurality of first electrode unit regions and a plurality of openings thereon, and each of the first electrode unit regions comprising at least one first transparent electrode;
a roll of second flexible transparent substrate, having a plurality of second electrode unit regions thereon, and each of the second electrode unit regions comprising at least one second transparent electrode, wherein the second electrode unit regions correspondingly face to the first electrode unit regions;
a plurality of first electrical connection terminals and a plurality of second electrical connection terminals, disposed on the roll of second flexible transparent substrate;
a plurality of first connection wires, connected to the first transparent electrodes;
a plurality of conducting contacts, connected to the first connection wires and the first electrical connection terminals;
a plurality of second connection wires, connected to the second transparent electrodes and having second electrical connection terminals;
a plurality of flexible printed circuits (FPCs), passing through the openings and connected to the first electrical connection terminals and the second electrical connection terminals exposed by the openings;
a plurality of spacer dots, disposed between the first transparent electrodes and the second transparent electrodes, for isolating the first transparent electrodes and the second transparent electrodes in a non-touch situation; and
a plurality of insulation frames, sealing surroundings of the first electrode unit regions and the second electrode unit regions corresponding to each other respectively, and isolating the first connection wires and the second connection wires respectively.

18. The flexible resistive touch sensor structure as claimed in claim 17, wherein materials of the roll of first flexible transparent substrate and the roll of second flexible transparent substrate respectively comprise polyethylene terephthalate, polycarbonate or flexible glass.

19. The flexible resistive touch sensor structure as claimed in claim 17, wherein materials of the first transparent electrodes and the second transparent electrodes respectively comprise transparent conductive oxide, an organic transparent conductive material, nano metal or carbon nanotube.

20. The flexible resistive touch sensor structure as claimed in claim 17, wherein the first transparent electrodes and the second transparent electrodes respectively comprise single-layer structures or multi-layer structures.

21. The flexible resistive touch sensor structure as claimed in claim 17, wherein materials of the first connection wires and the second connection wires respectively comprise conductive silver paste or a metal material.

22. The flexible resistive touch sensor structure as claimed in claim 17, wherein a material of the spacer dots comprises a dielectric material.

23. The flexible resistive touch sensor structure as claimed in claim 17, wherein a material of the insulation frames comprises ultraviolet-sensitive adhesive.

24. The flexible resistive touch sensor structure as claimed in claim 17, wherein materials of the first electrical connection terminals and the second electrical connection terminals respectively comprise conductive silver paste or a metal material.

25. The flexible resistive touch sensor structure as claimed in claim 17, wherein a material of the conducting contacts comprises conductive silver paste.
